(19) United States
(12) Patent Application Publication
(10) Pub. No.: US 2009/0018818 A1
(43) Pub. Date: Jan. 15, 2009

(54) OPERATING DEVICE FOR NATURAL LANGUAGE INPUT

(75) Inventors: Tsung-Han Tsai, Taipei City (TW); Chen-Wei Su, Taipei City (TW); Chun-Pin Fang, Taipei City (TW)

Correspondence Address: AIBELIVE CO., LTD., P.O.BOX 108-00403, TAIPEI, 106, TW

(73) Assignee: AIBELIVE CO., LTD., Taipei City (TW)

(21) Appl. No.: 11/775,243

(22) Filed: Jul. 10, 2007

(51) Int. Cl. G06F 17/27

(52) U.S. Cl. 704/9

(57) ABSTRACT

An operating device for natural language input is disclosed. A user can express its own request to the operating device by inputting natural language, then a processor determines format of natural language, if the natural language is voice format, a voice identification cell transforms it into word data and transmits to a natural language analysis unit; if the natural language is word or character identification format, the natural language analysis unit directly analyzes sentence type and issues a instruction accordingly, and then, an executive interface is to find out a matched equipment end to transmit the instruction for operating in real time, such design can respond to equipment end as required by the user so as to achieve a best man-machine communicating channel.

### BACKGROUND OF THE INVENTION

1. Field of the Invention

This invention relates to an operating device for natural language input, more particularly, the user is to input request in natural language, and the operating device can find out the matched equipment end to have real-time interactive response.

2. Description of the Related Art

The existing intelligent home appliance indicates appliance with network or language input function, since these home appliances are equipped with network communication or language input interface, its network communication interface can use network communication protocol, so that intelligent home appliance can be linked with network, thus, user can operate home appliance by issuing a remote instruction, and language input is used for operating nearby equipment, the modern technology is focusing on affinity of man-machine interface, that is to say, to do best to reduce reliance on operating skill so as to improve its correctness and effectiveness during operating.

Usually, such intelligent home appliance is operated by computer which only understands two types of signal, namely, “1” and “0” indicating “on” or “off”. However, people don't like to express everything by “0” or “1”, thus, people invented combined and high-grade language, however, above said computer languages have following disadvantages, namely, as user wants to operate such intelligent home appliances in remote or nearby, such appliance can not understand what user really requires, user must issue clear instruction for such operation, for example, in KTV room, if user says “my microphone must be louder”, however, the microphone cannot understand what user's real request is, it does nothing until clear instruction issued by user, and user doesn't know volume of microphone is comprised by decibel when issuing instruction, but adjust the volume by contrast, therefore, such setup can only issue operating instruction basing on “clear” instruction that is not convenient for man-machine interface operating.

Besides, if program computer language, the programmer must first remember all codes of instruction and meaning of codes of computer, meanwhile, programmer has to process each piece of instruction, memory distribution and input/output of each group of data and to remember status of working unit used in each step during programming, so, such job is very complicated and takes more times than its real operating time, the programmed programs are instruction codes comprised by “0” and “1”, such program is not intuitive and easy to occur error.

In addition, according to above said example, the traditional computer is calculated with Boolean searching characterized by quickness, precision and correctness, however, it can not calculate what humankind really require, such as feeling, emotion and viewpoint, etc., which can not be quantified; in the real world, many thinking process of humankind are very fuzzy, for example, tune up volume a little loud, the “a little loud” is very fuzzy, humankind can read it, computer can do nothing about it, besides, due to different background and education of each person, words and sentences used are different, thereby, at present, what is required to solve and to overcome is how to analyze words and sentences often used by individual so as to operate equipment and machine in real-time.

### SUMMARY OF THE INVENTION

The present invention has been accomplished under the circumstances in view. It is therefore the main object of the present invention to provide a operating device, which when the user inputs natural language, a processor of the operating device can determine format of the natural language, if the natural language is voice format, it is transmitted to a voice identification unit to transform into word data, then transmit it to a natural language analysis unit; if the natural language is word or character format, it is directly transmitted to the natural language analysis unit to analyzes sentence type, and the natural language analysis unit issues a matched instruction accordingly, and then, an executive interface of the operating device is to find out a matched equipment end to transmit the matched instruction for operation in real time, such that, the present invention can respond to the equipment end as required by the user so as to reach the best man-machine communication channel.

### BRIEF DESCRIPTION OF THE DRAWINGS

FIG. 1 is a block diagram in accordance with a first embodiment of the present invention.

FIG. 2 is a flow chart according to the present invention.

FIG. 3 is a flow chart of the natural language analysis unit according to the present invention.

FIG. 4 is a block diagram in accordance with a second embodiment of the present invention.

FIG. 5 is a block diagram in accordance with a third embodiment of the present invention.

FIG. 6 is a block diagram in accordance with a fourth embodiment of the present invention.

### DETAILED DESCRIPTION OF THE PREFERRED EMBODIMENT

The present invention allows a user to operate equipments directly with natural language, for example, usually, a air conditioner can adjust temperature as instructed by the user, namely, the user issues a direct instruction to the air conditioner (such as 24° C. and strong wind), but the user has to know in which phase the existing temperature and wind speed now when setting a next step; however, the air conditioner knows nothing about feeling of the user, so the air conditioner can only change according to the instruction. Thus, if the user operates the air conditioner with technical measure of the present invention, the user can input the current feeling with natural language, for example, the user says “it is too hot to adjust down temperature of air conditioner and speed up wind speed”, or “shall we adjust down temperature of air conditioner further?”. Thus, the present invention can analyze the user's meaning automatically so as to understand the user's request accordingly, then to adjust the relative temperature and wind speed of the air conditioner, particularly, the user can operate the equipments in real-time by natural language with same meanings, so the natural language can express the user's request to operate the equipments but not only by the instructions.

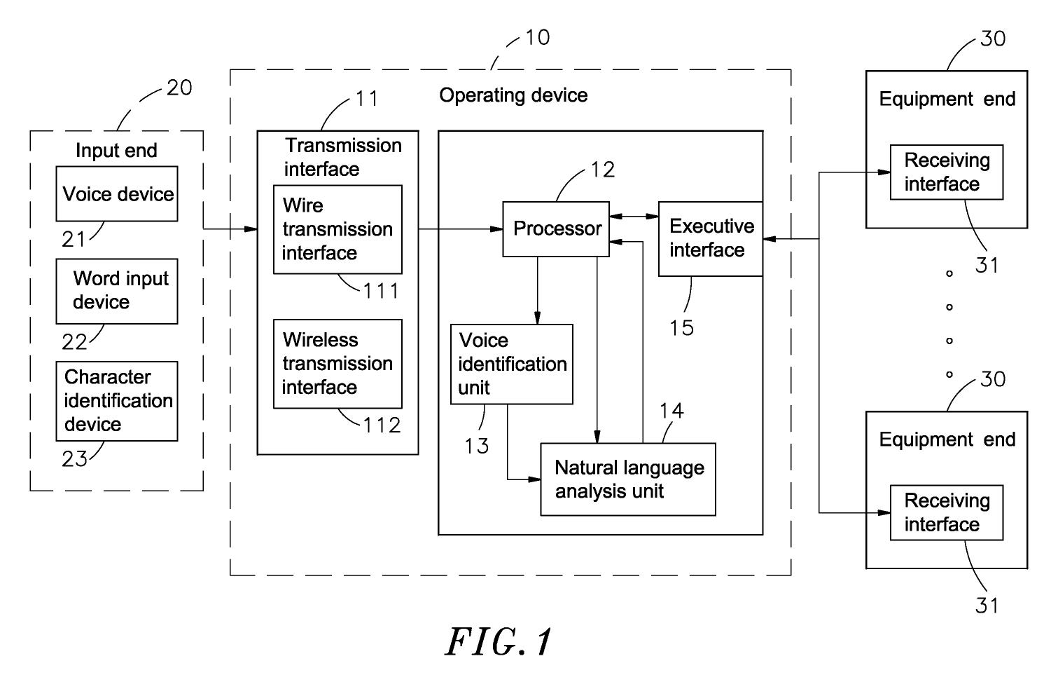

Referring to FIG. 1, an operating device 10 in accordance with a first embodiment of the present invention is shown comprised of a transmission interface 11, a processor 12, a voice identification unit 13, a natural language analysis unit 14 and an executive interface 15. The transmission interface 11 can be a wire transmission interface 111 and a wireless transmission interface 112, and is used for receiving or transmitting voice, word or character identification data, furthermore, the transmission interface 11 can be built-in or connected with the operating device 10. The processor 12 can transmits the voice data received by transmission interface 11 to the voice identification unit 13 for identification, then, the identified voice data is transmitted to the natural language analysis unit 14 for judgment, besides, the processor 12 can also directly transmit the words or character identification data to the natural language analysis unit 14 for judgment.

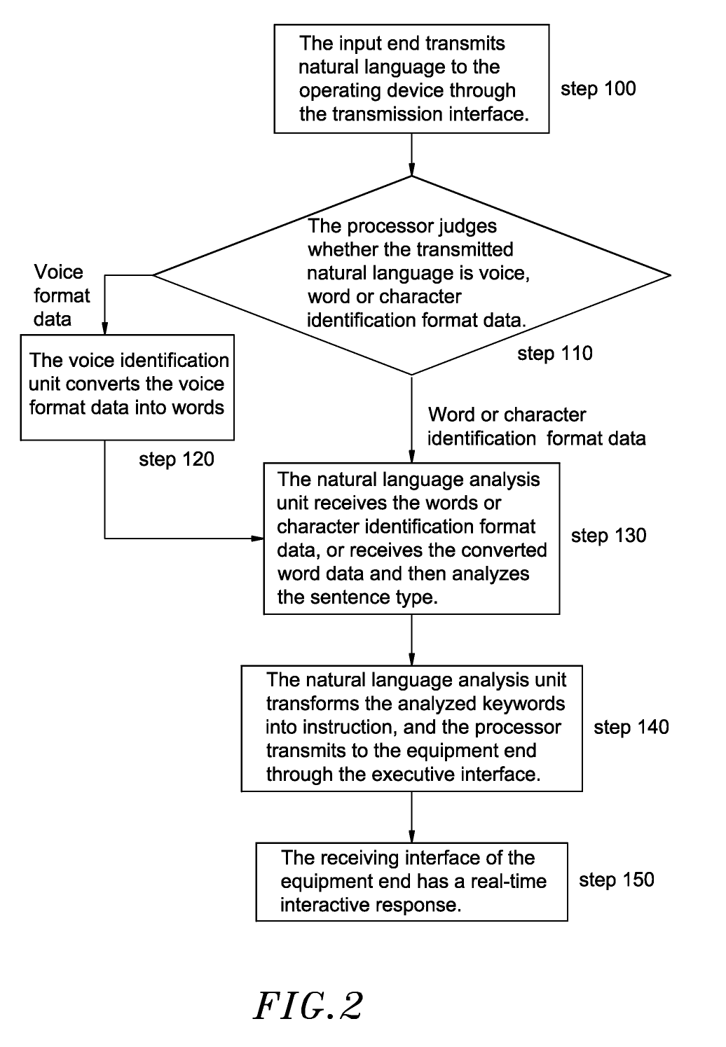

Meanwhile, please refer to FIG. 1 and FIG. 2, when an input end 20 transmits natural language to the operating device 10, the operating flow of an equipment end 30 is as follows.

(100) The input end 20 transmits natural language to the operating device 10 through the transmission interface 11.

(110) The processor 12 of the operating device 10 judges whether the transmitted natural language is voice, word or character identification format data, and proceeds to step (120) if the transmitted natural language is voice format data, or proceeds to step (130) if the transmitted natural language is word or character identification format data.

(120) The processor 12 transmits the voice format data to the voice identification unit 13 for word conversion and process to step (130).

(130) The natural language analysis unit 14 receives the words or character identification format data transmitted by the process 12, or receives the converted word data from the voice format data transmitted by the language identification unit 13 and then analyzes the sentence type of the natural language.

(140) The natural language analysis unit 14 transforms the analyzed keywords into instructions and transmits to the processor 12, and then the processor 12 transmits the instructions to a receiving interface 31 of the equipment end 30 through the executive interface 15.

(150) The receiving interface 31 of the equipment end 30 will have a real-time interactive response after received instruction.

The input end 20 can be a voice device 21, a word input device 22 or a character identification device 23. The user is allowed to input natural language into the voice device 21 (such as microphone and mobile phone) in oral language, express natural language in words mode, namely, the user can input words into the operating device 10 by the word input device 22 (such as computer, mobile phone, Notebook), or use character identification device 23 (such as scanner, projector and linear scanner) to transform the scanned image into words by OCR character identification mode and then transmit to the operating device 10.

The input end 20 can transmit voice and word format data into the operating device 10 through the transmission interface 11 which can be a wire transmission interface 111 or a wireless transmission interface 112. The wire transmission interface 111 can be network, a phone line, a transmission line or a coaxial cable, and the wireless transmission interface 112 can be a antenna interface, a frequency carrier interface, an infrared interface, a Bluetooth interface, etc. The transmission interface 10 is only used for transmitting voice and word format data into the processor 12 of the operating device 10 for further processing.

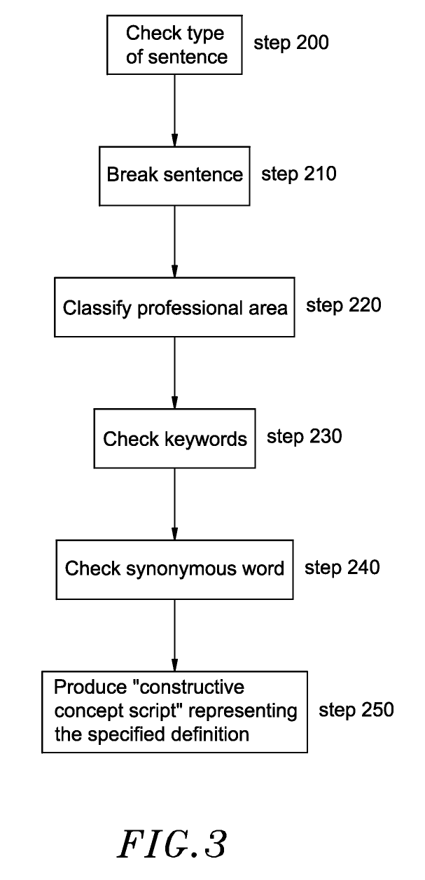

According to the above description, when the processor 12 receives voice and word format data transmitted by the transmission interface 11, the processor 12 can judge the format data; if it is voice format data, it will be transmitted to the voice identification unit 13 to transform into word, then, transmit to the natural language analysis unit 14; if it is word format data, it will be directly transmitted to the natural language analysis unit 14 for further judgment, please refer to FIG. 3 at the same time, the judgment flow of the natural language analysis unit 14 is as follows.

(200) Check a sentence type and confirm whether the sentence is a required sentence or not, such as an imperative or question sentence, and proceeds to step (201) if the sentence is a required sentence.

(210) Break the inputted sentence.

(220) Classify professional area and endow property to each word after broken, for example, it is a professional expression or personnel idiom.

(230) Check keywords in the sentence, and it is usually in two types including certain tasks or motions representing the request and relevant terms representing the request.

(240) Check whether there is a keywords or synonymous words in the imperative or question sentence.

(250) Produce “constructive concept script” representing a specific instruction.

The above classification of professional area is to compare the input natural language with database; if there is a relevant professional expression in the natural language, the database is to determine the natural language as professional words; if the natural language is personnel idiom, the database is to determine the natural language as usual words; if the database couldn't determine and may define the natural language as new words.

Thus, the natural language analysis unit 14 can transform word data into a “constructive concept script” representing a specific instruction, which matches with a “constructive concept script” built-in the database. The “constructive concept script” includes two groups: one is a “key event” and another one is a “term”, wherein the “key event” contains sentence format and most keywords relating to requests (such as professional words or usual words), and each keywords also contain lots of words to construct a tree-shaped structure; in addition, the “term” has a tree-shaped structural contents comprised by most keywords and words, so that the natural language input by the user produces one “constructive concept script”, and searches keywords of the “constructive concept script” in the database by professional words or usual words, and also further searches other related “key event” and “term” in the database according to keywords and finds out other possible “constructive concept script” repeatedly, and then, further finds other possible “key event” and “term” according to synonymous words in other “constructive concept script”, so as to search the most correct “constructive concept script” and transmit back the matched instruction to the processor 12.

If the user input “more cool air please” in natural language, according to above descriptions, the natural language will be transformed into words by the voice identification unit 13 and the natural language analysis cell 14 to produce a “constructive concept script”, and there is a “constructive concept script” representing “tune down cool air” and “tune up cool air” in the database, after logic comparison and judgment, the analyzed “constructive concept script” of natural language can find out the “constructive concept script” which precisely coincides with the database, then, connect the matched instruction, and the processor 12 transmits the instruction to the executive interface 15 which transmits to the equipment end 30 for real-time interactive operation.

According to the above descriptions, the present invention is able to let the user express own request to the operating device 10 by inputting natural language (such as voice, word or character identification), and the natural language analysis unit 14 in the operating device 10 analyzes the most coincided “constructive concept script” and produces a matched instruction, and then, the executive interface 15 finds out the matched equipment end 30 for real-time operation, such that, the present invention can make real-time response to equipment end 30 according to request of the user so as to achieve the best man-machine communicating channel.

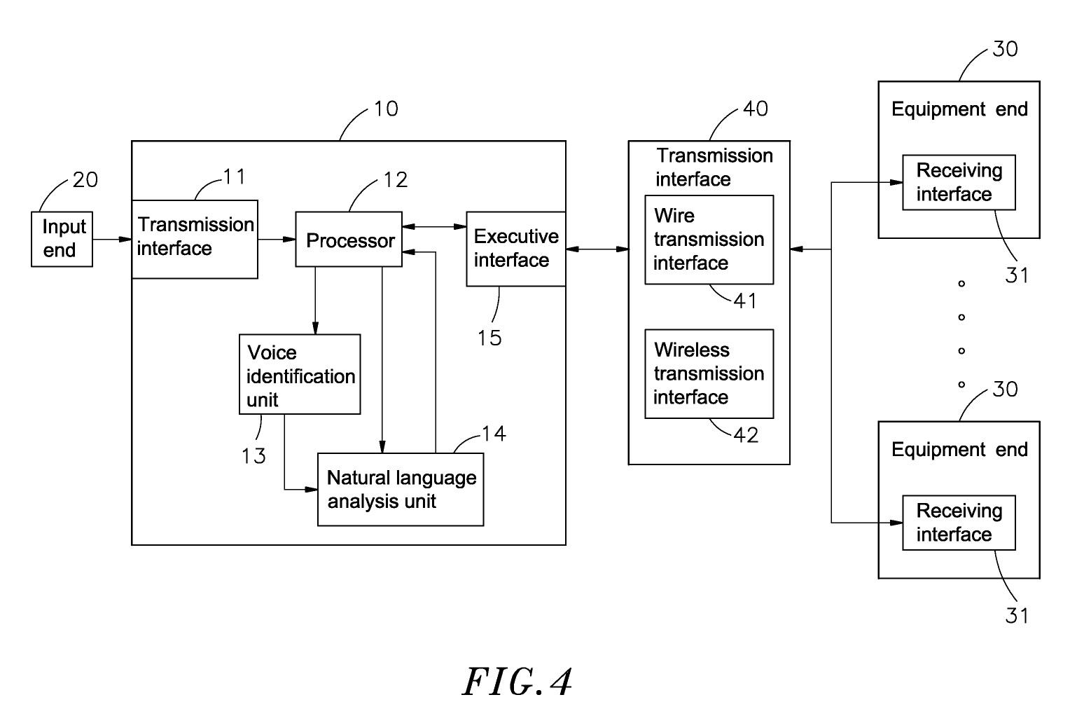

FIG. 4 is a block diagram in accordance with a second embodiment of the present invention. Similar to the aforesaid first embodiment, an operating device 10 of this second embodiment is comprised of a wire transmission interface 111, a processor 12, a voice identification unit 13, a natural language analysis unit 14 and an executive interface 15. The executive interface 15 of the operating device 10 can transmit instructions to an equipment end 30 through another transmission interface 40 which can be a wire transmission interface 41 or a wireless transmission interface 42. The wire transmission interface 41 is network, a phone line, a transmission line or a coaxial cable, and the wireless transmission interface 42 is a antenna interface, a frequency carrier interface, an infrared interface, a Bluetooth interface, etc., The transmission interface 40 is only used for transmitting the instructions transmitted by the executive interface 15 to the equipment end 30 for real-time interactive response.

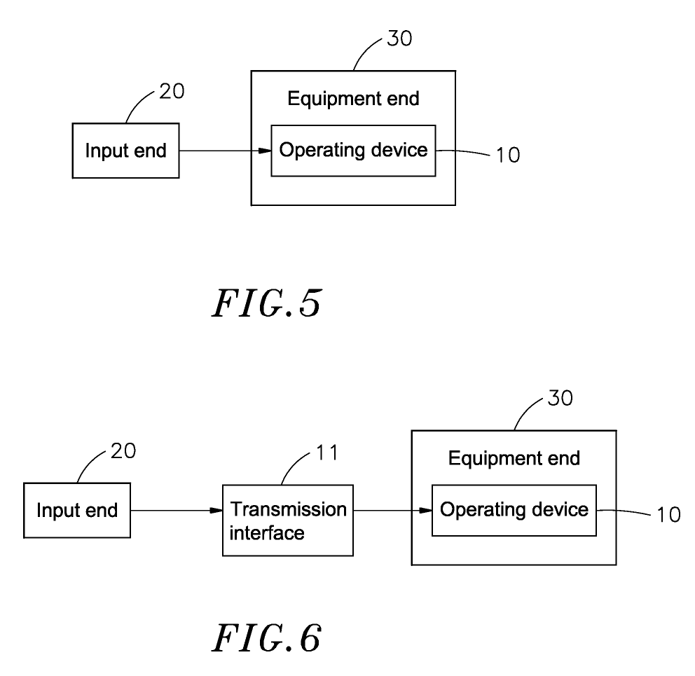

Besides, the operating device 10 can be built-in the equipment end 30, please refer to FIG. 5 and FIG. 6, they are the block diagrams in accordance with a third embodiment and a fourth embodiment of the present invention respectively. According to these two embodiments, the operating device 10 can be built-in the equipment end 30 to allow the user to input natural language into the built-in operating device 10 of the equipment port 30 via the input end 20, so that the equipment end 30 can respond to a request of the user in real-time (as shown in FIG. 5), or as the operating device 10 is built-in the equipment end 30, the transmission interface 11 of the operating device 10 is connected outside of the equipment end 30, and the user can input natural language through the input end 20 to transmit voice, word or character identification data to the built-in operating device 10 of the equipment port 30 for real-time response (as shown in FIG. 6).

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An operating device for natural language input comprising a transmission interface, a processor, a voice identification unit, a natural language analysis unit and an executive interface, wherein:
said transmission interface being connected to an input unit and adapted to receive voice, words or character identification data of natural language from said input end to said processor;
said processor being adapted to judge format of the voice, words or character identification data for transmitting the voice format data to said voice identification unit or transmitting the word or character identification format data to said natural language analysis unit directly;
said voice identification unit being adapted to transform the voice format data into words data and transmit to said natural language analysis unit; and
said natural language analysis unit being adapted to analyzes sentence type of the words data and transform analyzed keywords into instructions and transmit it to said processor, and then said processor further transmitting the instructions to a matched equipment unit via said executive interface for real-time interactive response.

2. The operating device for natural language input of claim 1, wherein said transmission interface of said operating device can be a wire transmission interface and a wireless transmission interface.

3. The operating device for natural language input of claim 2, wherein said wire transmission interface can be network, a phone line, a transmission line and a coaxial cable.

4. The operating device for natural language input of claim 2, wherein said wireless transmission interface can be an antenna interface, a frequency carrier interface, an infrared interface and a Bluetooth interface.

5. The operating device for natural language input of claim 1, wherein said input end can be a voice device, a word input device and a character identification device.

6. The operating device for natural language input of claim 5, wherein said voice device can be a microphone and a mobile phone.

7. The operating device for natural language input of claim 5, wherein said word input device can be a computer, a mobile phone and a notebook.

8. The operating device for natural language input of claim 5, wherein said character identification device can be a scanner, a projector and a linear scanner to transform scanned images into words in OCR character identification mode.

9. The operating device for natural language input of claim 1, wherein said executive interface of said operating device can transmit the instruction to said equipment unit via another transmission interface, and said another transmission interface can be a wire transmission interface or a wireless transmission interface.

10. The operating device for natural language input of claim 9, wherein said wire transmission interface can be network, a phone line, a transmission line and a coaxial cable.

11. The operating device for natural language input of claim 9, wherein said wireless transmission interface can be an antenna interface, a frequency carrier interface, an infrared interface and a Bluetooth interface.

12. The operating device for natural language input of claim 1, wherein said operating device is built-in the equipment unit, and said input end directly inputs natural language into said built-in operating device of said equipment end.
